(19) United States
(12) Patent Application Publication
(10) Pub. No.: US 2014/0176484 A1
(43) Pub. Date: Jun. 26, 2014

(54) CAPACITIVE TOUCH DISPLAY APPARATUS

(71) Applicant: HANNSTAR DISPLAY CORPORATION, New Taipei City (TW)

(72) Inventors: Kun-Hua Tsai, Tainan City (TW); Hsing-Ying Lee, Tainan City (TW); Ping-Yuan Su, Kaohsiung City (TW); Yu-Cheng Lin, Pingtung County (TW)

(73) Assignee: HANNSTAR DISPLAY CORPORATION, New Taipei City (TW)

(21) Appl. No.: 13/776,729

(22) Filed: Feb. 26, 2013

(30) Foreign Application Priority Data
Dec. 26, 2012 (CN) 201210574412.7

(51) Int. Cl. G06F 3/041

(52) U.S. Cl. CPC G06F 3/0412
USPC 345/174

(57) ABSTRACT

A capacitive touch display apparatus includes a liquid crystal (LC) display module, a touch panel and a judgment unit. The LC display module includes an active device array substrate, a color filter (CF) substrate, and an LC layer disposed between inner sides of the two substrates. The touch panel includes a single touch sensing layer fabricated on an outer side of the CF substrate and a cover lens disposed on the single touch sensing layer. The single touch sensing layer includes a transmitter patterned electrode and multiple receiver patterned electrodes. A same inductive capacitor is formed between each receiver patterned electrode and the transmitter patterned electrode. The judgment unit transmits a scan signal to the transmitter patterned electrode, and determines whether there is an occurrence of a single-touch event or a multi-touch event by analyzing inductive signals from the respective receiver patterned electrodes.

### CROSS-REFERENCE TO RELATED APPLICATION

This application claims the priority benefit of China application serial no. 201210574412.7, filed on Dec. 26, 2012. The entirety of the above-mentioned patent application is hereby incorporated by reference herein and made a part of this specification.

### BACKGROUND OF THE INVENTION

1. Field of the Invention

The present invention relates to a touch display apparatus, and more particularly, to a capacitive touch display apparatus.

2. Description of Related Art

Technology advancement has caused electronic devices to be more and more widely used. In particular, electronic devices equipped with a touch panel are now becoming the most popular consumer electronic products.

In the current touch panels, resistive type and capacitive type touch panels are the main stream. The resistive touch panels have low light transmission rate, poor durability and low accuracy and, therefore, are suitable for low end consumer electronic products. In comparison, the capacitive touch panels have better sensitivity, stability and accuracy and, therefore, are suitable for relatively higher end consumer electronic products.

Currently, the touch panel, regardless of the resistive type or capacitive type, can be bonded with a display panel in an on-cell manner, or integrated with the display panel in an in-cell manner. However, no matter how (on-cell or in-cell) the resistive/capacitive touch panel is bonded/integrated with the display panel, it is desired to simply and accurately judge/detect a touch (click) location on the touch panel.

### SUMMARY OF THE INVENTION

One exemplary embodiment of the present invention provides a capacitive touch display apparatus which includes a liquid crystal display module, a touch panel, and a judgment unit. The liquid crystal display module includes an active device array substrate, a color filter substrate, and a liquid crystal layer disposed between an inner side of the active device array substrate and an inner side of the color filter substrate.

The touch panel includes a single touch sensing layer and a cover lens disposed on the single touch sensing layer. The single touch sensing layer may be (directly) fabricated on an outer side of the color filter substrate. The single touch sensing layer includes a first transmitter patterned electrode and a plurality of first receiver patterned electrodes corresponding to the first transmitter patterned electrode. There is a first inductive capacitor between each of the first receiver patterned electrodes and the first transmitter patterned electrode, and the first inductive capacitors are equal to each other.

The judgment unit is electrically connected with the first transmitter patterned electrode and the first receiver patterned electrodes. The judgment unit is configured to transmit a first scan signal to the first transmitter patterned electrode, and determine whether there is an occurrence of a single-touch event or a multi-touch event by analyzing a plurality of first inductive signals from the respective first receiver patterned electrodes.

In one exemplary embodiment, the single touch sensing layer further includes a second transmitter patterned electrode and a plurality of second receiver patterned electrodes corresponding to the second transmitter patterned electrode, and there is a second inductive capacitor is between each of the second receiver patterned electrodes and the second transmitter patterned electrode, and the second inductive capacitors are equal to the first inductive capacitors.

In one exemplary embodiment, the judgment unit is further electrically connected with the second transmitter patterned electrode and the second receiver patterned electrodes. In addition, the judgment unit further transmits a second scan signal following the first scan signal to the second transmitter patterned electrode, and determines whether there is the occurrence of the single-touch event or the multi-touch event by analyzing simultaneously the first inductive signals and a plurality of second inductive signals from the respective receiver patterned electrodes.

In one exemplary embodiment, at least one of the first inductive capacitors and the second inductive capacitors varies with the occurrence of the single-touch event or the multi-touch event. In this case, when the judgment unit analyzes that amplitudes of the first inductive signals and amplitudes of the second inductive signals are the same, the judgment unit determines that there is no the occurrence of the single-touch event or the multi-touch event.

When the judgment unit analyzes that the amplitude of only one of the first inductive signals is different from the amplitudes of the remaining first inductive signals and the second inductive signals, the judgment unit determines that there is the occurrence of the single-touch event. When the judgment unit analyzes that the amplitudes of only one of the second inductive signals is different from the amplitudes of the remaining second inductive signals and the first inductive signals, the judgment unit determines that there is the occurrence of the single-touch event.

When the judgment unit analyzes that the amplitudes of at least one of the first inductive signals and at least one of the second inductive signals are different from the amplitudes of the remaining first inductive signals and the remaining second inductive signals, the judgment unit determines that there is the occurrence of the multi-touch event. When the judgment unit analyzes that the amplitudes of at least two of the first inductive signals are different from the amplitudes of the remaining first inductive signals and the second inductive signals, the judgment unit determines that there is the occurrence of the multi-touch event. When the judgment unit analyzes that the amplitudes of at least two of the second inductive signals are different from the amplitudes of the remaining second inductive signals and the first inductive signals, the judgment unit determines that there is the occurrence of the multi-touch event.

In one exemplary embodiment, a scanning frequency corresponding to the first and second scan signals is higher than a frame rate of the liquid crystal display module.

In one exemplary embodiment, the liquid crystal display module may further include an active array device layer disposed on the inner side of the active device array substrate; a first alignment layer disposed between the active device array layer and the liquid crystal layer; a second alignment layer disposed between the color filter substrate and the liquid crystal layer; a common electrode layer disposed between the color filter substrate and the second alignment layer; and a color filter layer disposed between the color filter substrate and the common electrode layer. In addition, the liquid crystal display module may further include a lower polarizer disposed on an outer side of the active device array substrate, and a backlight module disposed below the lower polarizer.

In one exemplary embodiment, the touch panel may further include an upper polarizer disposed on the single touch sensing layer, and a transparent adhesive layer disposed between the cover lens and the upper polarizer.

In one exemplary embodiment, the transparent adhesive layer may be an optically-clear adhesive (OCA) layer or a liquid optically-clear adhesive (LOCA) layer.

In view of the foregoing, various embodiments of the present invention provide a capacitive touch display apparatus having an on-cell-like touch panel, the touch detection scheme of which can be carried out using simplified hardware structures and can achieve accurate single-touch and/or multi-touch detection/judgment with high SNR (signal-to-noise ratio).

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A and FIG. 1B together illustrate a capacitive touch display apparatus according to one exemplary embodiment.

FIG. 2A and FIG. 2B together illustrate a touch detection scheme carried out by the capacitive touch display apparatus of FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. Where possible, the same reference numerals refer to the same or similar parts throughout the drawing and the specification.

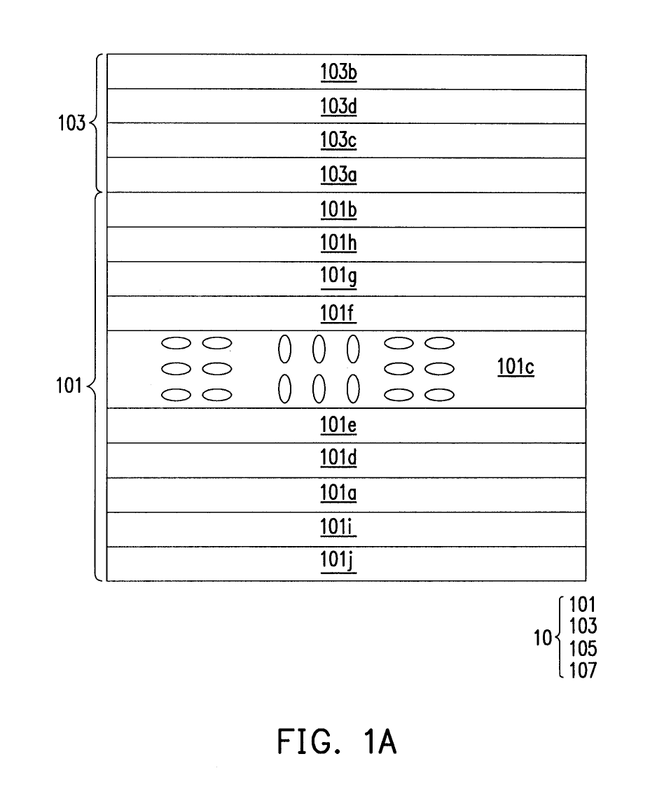

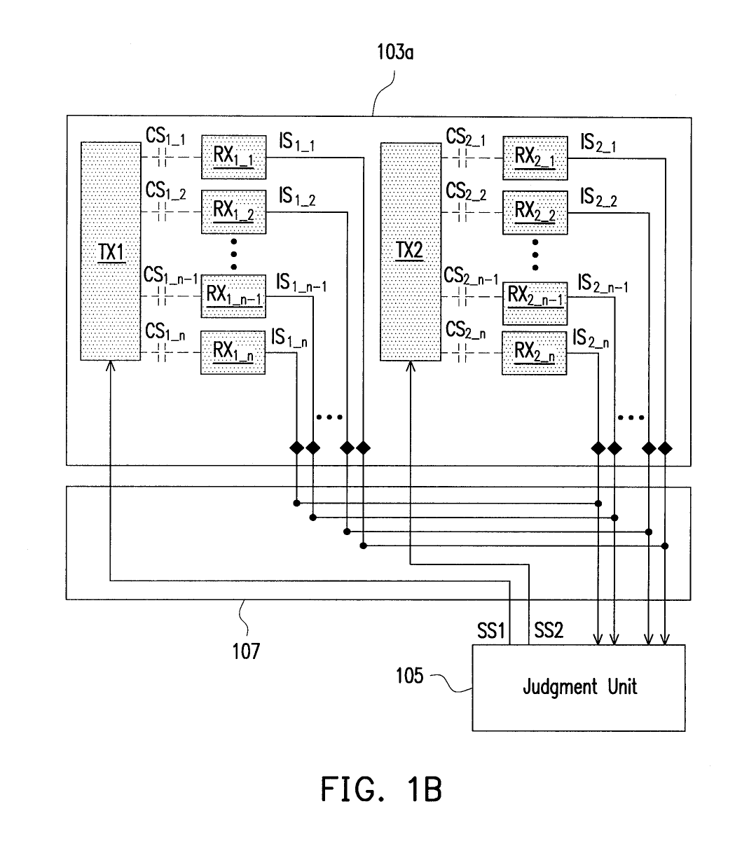

FIG. 1A and FIG. 1B together illustrate a capacitive touch display apparatus 10 according to one exemplary embodiment. Referring to FIG. 1A and FIG. 1B, the capacitive touch display apparatus 10 includes a liquid crystal display (LCD) module 101, an on-cell-like touch panel 103, a judgment unit 105, and a flexible printed circuit (FPC) board 107.

In the exemplary embodiment illustrated in FIG. 1A, the LCD module 101 includes, but not limited to, the following components:

an active device array substrate 101a, also referred to as a pixel array substrate or a lower substrate;

a color filter substrate 101b, also referred to as an opposite substrate or an upper substrate;

a liquid crystal layer 101c disposed between an inner side of the active device array substrate 101a and an inner side of the color filter substrate 101b;

an active device (e.g. film transistor, TFT) array layer 101d disposed on the inner side of the active device array substrate 101a;

an alignment layer 101e disposed between the active device array layer 101d and the liquid crystal layer 101c;

an alignment layer 101f disposed between the color filter substrate 101b and the liquid crystal layer 101c;

a common electrode layer 101g disposed between the color filter substrate 101b and the alignment layer 101f;

a color filter layer 101h disposed between the color filter substrate 101b and the common electrode layer 101g, wherein the color filter layer 101h includes color filter films (not shown) in red (R), green (G) and blue (B) and black matrixes (not shown) disposed between the color filter films;

a lower polarizer 101i disposed on an outer side of the active device array substrate 101a; and

a backlight module 101j disposed below the lower polarizer 101i, which may, for example, be a direct-type or side-type cold cathode fluorescent lamp (CCFL) backlight module or a light-emitting diode (LED) backlight module.

It should be noted that the LCD module 101 may also include other components different from the above components depending upon actual requirements.

On the other hand, as shown in FIG. 1A, the touch panel 103 may include, but not limited to, the following components:

a single touch sensing layer 103a;

a cover lens 103b disposed on the single touch sensing layer 103a;

an upper polarizer 103c disposed on the single touch sensing layer 103a; and

a transparent adhesive layer 103d disposed between the cover lens 103b and the upper polarizer 103c, non-limiting examples of which include an optically-clear adhesive layer (OCA layer) and a liquid optically-clear adhesive layer (LOCA layer).

In this exemplary embodiment, the single touch sensing layer 103a may be directly fabricated (for example, but not limited to, sputtering) on the outer side of the color filter substrate 101b and, as shown in FIG. 1B (but not limited to what is illustrated), includes m (m=2) transmitter patterned electrodes (TX1, TX2), n receiver patterned electrodes RX₁_{_{—}}₁ to RX₁_{_{—}}ₙ corresponding to the transmitter patterned electrode TX1, and n receiver patterned electrodes RX₂_{_{—}}₁ to RX₂_{_{—}}ₙ corresponding to the transmitter patterned electrode TX2, where m, n are each a preset positive integer. More specifically, the single touch sensing layer 103a illustrated in FIG. 1B has a touch resolution of m(=2)*n(≧2) (i.e. two transmitter patterned electrodes (TX1, TX2) and n receiver patterned electrodes (RX₁_{_{—}}₁ to RX₁_{_{—}}ₙ/RX₂_{_{—}}₁ to RX₂_{_{—}}ₙ)). It is noted, however, that values of m and n may be determined based on actual requirements of the touch resolution of the single touch sensing layer 103a. In the present embodiment, the touch resolution m(=2)*n(≧2) of the single touch sensing layer 103a is taken as an example.

If there is no touch event on the touch panel 103, the receiver patterned electrodes RX₁_{_{—}}₁ to RX₁_{_{—}}ₙ and the transmitter patterned electrode TX1 respectively form inductive capacitors CS₁_{_{—}}₁ to CS₁_{_{—}}ₙ equal to each other, i.e. CS₁_{_{—}}₁=CS₁_{_{—}}₂=CS₁_{_{—}}₃= . . . =CS₁_{_{—}}ₙ. For example, the receiver patterned electrode RX₁_{_{—}}₁ and the transmitter patterned electrode TX1 form an inductive capacitor CS₁_{_{—}}₁, the receiver patterned electrode RX₁_{_{—}}₂ and the transmitter patterned electrode TX1 form an inductive capacitor CS₁_{_{—}}₂, and, by analogy, the receiver patterned electrode RX₁_{_{—}}ₙ and the transmitter patterned electrode TX1 form an inductive capacitor CS₁_{_{—}}ₙ.

Similarly, if there is no touch event on the touch panel 103, the receiver patterned electrodes RX₂_{_{—}}₁ to RX₂_{_{—}}ₙ and the transmitter patterned electrode TX2 respectively form inductive capacitors CS₂_{_{—}}₁ to CS₂_{_{—}}ₙ equal to the inductive capacitors CS₁_{_{—}}₁ to CS₁_{_{—}}ₙ, i.e. CS₁_{_{—}}_{k(=1˜n)}=CS₂_{_{—}}_{k(=1˜n)}. For example, the receiver patterned electrode RX2_1 and the transmitter patterned electrode TX2 form an inductive capacitor CS₂_{_{—}}₁, the receiver patterned electrode RX₂_{_{—}}₂ and the transmitter patterned electrode TX2 form an inductive capacitor CS₂_{_{—}}₂, and, by analogy, the receiver patterned electrode RX₂_{_{—}}ₙ and the transmitter patterned electrode TX2 form an inductive capacitor CS₂_{_{—}}ₙ.

It is noted that, in the present exemplary embodiment, at least one of the inductive capacitors CS₁_{_{—}}_{k(=1˜n)} and CS₂_{_{—}}_{k(=1˜n)} varies with the occurrence of a single-touch event or a multi-touch event. For example, depending upon actual requirements, the variation may be an increase or a decrease in capacitance. In addition, the “single-touch event” mentioned herein may be an operating/click action on the capacitive touch display apparatus 10 by a single finger of a user; the “multi-touch event” mentioned herein may be an operating/click action on the capacitive touch display apparatus 10 by multiple fingers of the user.

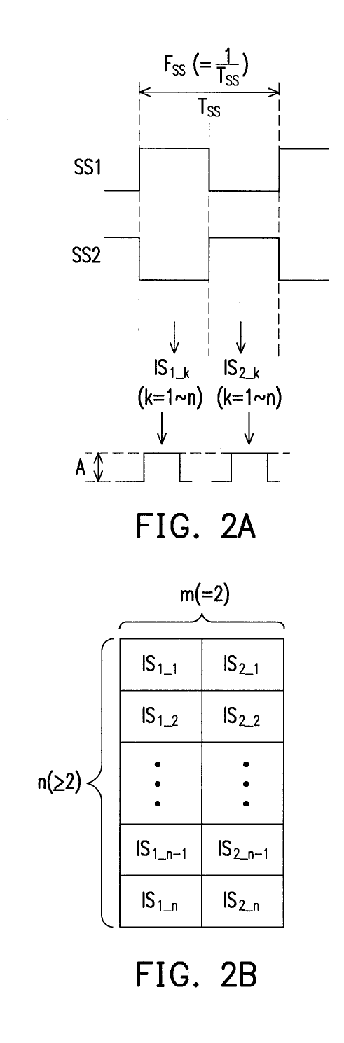

On the other hand, as shown in FIG. 1B, the judgment unit 105 may be electrically connected to the transmitter patterned electrodes (TX1, TX2) and the receiver patterned electrodes (RX₁_{_{—}}₁ to RX₁_{_{—}}ₙ, RX₂_{_{—}}₁ to RX₂_{_{—}}ₙ) through the FPC board 107. In the present exemplary embodiment, as shown in FIG. 2A and FIG. 2B, the judgment unit 105 is used to sequentially transmit scan signals SS1 and SS2 to the transmitter patterned electrodes TX1 and TX2 (i.e. the scan signal SS2 follows the scan signal SS1), and judges/determines whether there is an occurrence of the single-touch event or the multi-touch event by analyzing both inductive signals (IS₁_{_{—}}₁ to IS₁_{_{—}}ₙ) from the respective receiver patterned electrodes (RX₁_{_{—}}₁ to RX₁_{_{—}}ₙ) and inductive signals (IS₂_{_{—}}₁ to IS₂_{_{—}}ₙ) from the respective receiver patterned electrodes (RX₂_{_{—}}₁ to RX₂_{_{—}}ₙ).

It is noted that, because of the inductive capacitors CS₁_{_{—}}_{k(=1˜n)}, CS₂_{_{—}}_{k(=1˜n)}, when the transmitter patterned electrode TX1 receives the scan signal SS1 from the judgment unit 105, the receiver patterned electrodes (RX₁_{_{—}}₁ to RX₁_{_{—}}ₙ) provide the respective inductive signals (IS₁_{_{—}}₁ to IS₁_{_{—}}ₙ) to the judgment unit 105 in response to the scan signal SS1. For example, the receiver patterned electrode RX₁_{_{—}}₁ provides the inductive signal IS₁_{_{—}}₁ to the judgment unit 105 in response to the scan signal SS1, the receiver patterned electrode RX₁_{_{—}}₂ provides the inductive signal IS₁_{_{—}}₂ to the judgment unit 105 in response to the scan signal SS1, and, by analogy, the receiver patterned electrode RX₁_{_{—}}ₙ provides the inductive signal IS₁_{_{—}}ₙ to the judgment unit 105 in response to the scan signal SS1.

Similarly, when the transmitter patterned electrode TX2 receives the scan signal SS2 from the judgment unit 105, the receiver patterned electrodes (RX₂_{_{—}}₁ to RX₂_{_{—}}ₙ) provide the respective inductive signals (IS₂_{_{—}}₁ to IS₂_{_{—}}ₙ) to the judgment unit 105 in response to the scan signal SS2. For example, the receiver patterned electrode RX₂_{_{—}}₁ provides the inductive signal IS₂_{_{—}}₁ to the judgment unit 105 in response to the scan signal SS2, the receiver patterned electrode RX₂_{_{—}}₂ provides the inductive signal IS2_2 to the judgment unit 105 in response to the scan signal SS2, and, by analogy, the receiver patterned electrode RX₂_{_{—}}ₙ provides the inductive signal IS₂_{_{—}}ₙ to the judgment unit 105 in response to the scan signal SS2.

In the present exemplary embodiment, at least one of the inductive capacitors CS₁_{_{—}}_{k(=1˜n)}, CS₂_{_{—}}_{k(=1—n)} varies with the occurrence of the single-touch event or the multi-touch event, and the variation may, for example, be an increase or a decrease in capacitance. Therefore, when the judgment unit 105 analyzes that all the inductive signals (IS₁_{_{—}}₁ to IS₁_{_{—}}ₙ, IS₂_{_{—}}₁ to IS₂_{_{—}}ₙ) have same amplitude A, the judgment unit 105 immediately judges that there is no the occurrence of the single-touch event or the multi-touch event. The reason is that none of the inductive capacitors CS₁_{_{—}}_{k(=1˜n)}, CS₂_{_{—}}_{k(=1˜n}) varied and, as a result, the inductive signals (IS₁_{_{—}}₁ to IS₁_{_{—}}ₙ, IS₂_{_{—}}₁ to IS₂_{_{—}}ₙ) respectively provided by the receiver patterned electrodes (RX₁_{_{—}}₁ to RX₁_{_{—}}ₙ, RX₂_{_{—}}₁ to RX₂_{_{—}}ₙ) have the same amplitude A.

In addition, when the judgment unit 105 analyzes that only one inductive signal (for example, but not limited to, IS₁_{_{—}}₁) has a different amplitude A than the remaining inductive signals (IS₁_{_{—}}₂ to IS₁_{_{—}}ₙ, IS₂_{_{—}}₁ to IS₂_{_{—}}ₙ), then the judgment unit 105 judges that there is the occurrence of the single-touch event. The reason is that the inductive capacitor CS₁_{_{—}}₁ varied and the remaining inductive capacitors CS₁_{_{—}}_{k(=2˜n)}, CS₂_{_{—}}_{k(=1˜n)} did not vary and, as a result, the amplitude A of the inductive signal IS₁_{_{—}}₁ provided by the receiver patterned electrode RX₁_{_{—}}₁ is different from (e.g. greater than or smaller than) the amplitudes A of the inductive signals (IS₁_{_{—}}₂ to IS₁_{_{—}}ₙ, IS₂_{_{—}}₁ to IS₂_{_{—}}ₙ) respectively provided by the remaining receiver patterned electrodes (RX₁_{_{—}}₂ to RX₁_{_{—}}ₙ, RX₂_{_{—}}₁ to RX₂_{_{—}}ₙ).

Similarly, when the judgment unit 105 analyzes that only one inductive signal (for example, but not limited to, IS₂_{_{—}}ₙ) has a different amplitude A than the remaining inductive signals (IS₁_{_{—}}₁ to IS₁_{_{—}}ₙ, IS₂_{_{—}}₁ to IS₂_{_{—}}ₙ₋₁), then the judgment unit 105 judges that there is the occurrence of the single-touch event. The reason is that the inductive capacitor CS₂_{_{—}}ₙ varied and the remaining inductive capacitors CS₁_{_{—}}_{k(=1˜n)}, CS₂_{_{—}}_{k(=1˜n-1}) did not vary and, as a result, the amplitude A of the inductive signal IS₂_{_{—}}ₙ provided by the receiver patterned electrode RX₂_{_{—}}ₙ is different from (e.g. greater than or smaller than) the amplitudes A of the inductive signals (IS₁_{_{—}}₁ to IS₁_{_{—}}ₙ, IS₂_{_{—}}₁ to IS₂_{_{—}}ₙ₋₁) respectively provided by the remaining receiver patterned electrodes (RX₁_{_{—}}₁ to RX₁_{_{—}}ₙ, RX₂_{_{—}}₁ to RX₂_{_{—}}ₙ₋₁).

Moreover, when the judgment unit 105 analyzes that the amplitude A of at least one (for example, but not limited to, IS₁_{_{—}}₁) of the inductive signals (IS₁_{_{—}}₁ to IS₁_{_{—}}ₙ) and the amplitude A of at least one (for example, but not limited to, IS₂_{_{—}}₁) of the inductive signals (IS₂_{_{—}}₁ to IS₂_{_{—}}ₙ) are different from the amplitudes A of the remaining inductive signals CS₁_{_{—}}_{k(=2˜n)}, CS₂_{_{—}}_{k(=2˜n)}, then the judgment unit 105 judges that there is the occurrence of the multi-touch event (i.e. two-touch event). The reason is that the inductive capacitors CS₁_{_{—}}₁ and CS₂_{_{—}}₁ varied and the remaining inductive capacitors CS₁_{_{—}}_{k(=2˜n)}, CS₂_{_{—}}_{k(=2˜n)} did not vary and, as a result, the amplitudes A of the inductive signals (IS₁_{_{—}}₁, IS₂_{_{—}}₁) respectively provided by the receiver patterned electrodes (RX₁_{_{—}}₁, RX₂_{_{—}}₁) are different from (e.g. greater than or smaller than) the amplitudes A of the inductive signals (IS₁_{_{—}}₂ to IS₁_{_{—}}ₙ, IS₂_{_{—}}₂ to IS₂_{_{—}}ₙ) respectively provided by the remaining receiver patterned electrodes (RX₁_{_{—}}₂ to RX₁_{_{—}}ₙ, RX₂_{_{—}}₂ to RX₂_{_{—}}ₙ).

For another example, when the judgment unit 105 analyzes that the amplitudes A of at least two (for example, but not limited to, IS₁_{_{—}}₁, IS₁_{_{—}}₂) of the inductive signals (IS₁_{_{—}}₁ to IS₁_{_{—}}ₙ) and the amplitudes A of at least two (for example, but not limited to, IS₂_{_{—}}₁, IS₂_{_{—}}₂) of the inductive signals (IS₂_{_{—}}₁ to IS₂_{_{—}}ₙ) are different from the amplitudes A of the remaining inductive signals CS₁_{_{—}}_{k(=3˜n)}, CS₂_{_{—}}_{k(=3˜n)}, then the judgment unit 105 judges that there is the occurrence of the multi-touch event (i.e. four-touch event). The reason is that the inductive capacitors (CS₁_{_{—}}₁, CS₁_{_{—}}₂) and (CS₂_{_{—}}₁, CS₂_{_{—}}₂) varied and the remaining inductive capacitors CS₁_{_{—}}_{k(=3˜n)}, CS₂_{_{—}}_{k(=3˜n)} did not vary and, as a result, the amplitudes A of the inductive signals (IS₁_{_{—}}₁, IS₁_{_{—}}₂), (IS₂_{_{—}}₁, IS₂_{_{—}}₂) respectively provided by the receiver patterned electrodes (RX₁_{_{—}}₁, RX₁_{_{—}}₂), (RX₂_{_{—}}₁, RX₂_{_{—}}₂) are different from (e.g. greater than or smaller than) the amplitudes A of the inductive signals (IS₁_{_{—}}₃ to IS₁_{_{—}}ₙ, IS₂_{_{—}}₃ to IS₂_{_{—}}ₙ) respectively provided by the remaining receiver patterned electrodes (RX₁_{_{—}}₃ to RX₁_{_{—}}ₙ, RX₂_{_{—}}₃ to RX₂_{_{—}}ₙ).

Besides, when the judgment unit 105 analyzes that the amplitudes A of at least two (for example, but not limited to, IS₁_{_{—}}₁, IS₁_{_{—}}₂) of the inductive signals (IS₁_{_{—}}₁ to IS₁_{_{—}}ₙ) are different from the amplitudes A of the remaining inductive signals CS_k(=3˜n), CS₂_{_{—}}_{k(=1˜n)}, then the judgment unit 105 judges that there is the occurrence of the multi-touch event (i.e. two-touch event). The reason is that the inductive capacitors CS₁_{_{—}}₁ and CS₁_{_{—}}₂ varied and the remaining inductive capacitors CS₁_{_{—}}_{k(=3˜n)}, CS₂_{_{—}}_{k(=1˜n)} did not vary and, as a result, the amplitudes A of the inductive signal (IS1_1, IS1_2) respectively provided by the receiver patterned electrode (RX₁_{_{—}}₁, RX₁_{_{—}}₂) are different from (e.g. greater than or smaller than) the amplitudes A of the inductive signals (IS₁_{_{—}}₃ to IS₁_{_{—}}ₙ, IS₂_{_{—}}₁ to IS₂_{_{—}}ₙ) respectively provided by the remaining receiver patterned electrodes (RX₁_{_{—}}₃ to RX₁_{_{—}}ₙ, RX₂_{_{—}}₁ to RX₂_{_{—}}ₙ).

For another example, when the judgment unit 105 analyzes that the amplitudes A of three (for example, but not limited to, IS₁_{_{—}}₁ to IS₁_{_{—}}₃) of the inductive signals (IS₁_{_{—}}₁ to IS₁_{_{—}}ₙ) are different from the amplitudes A of the remaining inductive signals CS₁_{_{—}}_{k(=4˜n)}, CS₂_{_{—}}_{k(=1˜n)}, then the judgment unit 105 judges that there is the occurrence of the multi-touch event (i.e. three-touch event). The reason is that the inductive capacitors CS₁_{_{—}}_{k(=1˜3)} varied and the remaining inductive capacitors CS₁_{_{—}}_{k(=4˜n)}, CS₂_{_{—}}_{k(=1˜n)} did not vary and, as a result, the amplitudes A of the inductive signal IS₁_{_{—}}_{k(=1˜3)} respectively provided by the receiver patterned electrode RX₁_{_{—}}_{k(=1˜3)} are different from (e.g. greater than or smaller than) the amplitudes A of the inductive signals (IS₁_{_{—}}_{k(=4˜n)}, IS₂_{_{—}}_{k(=1˜n)}) respectively provided by the remaining receiver patterned electrodes (RX₁_{_{—}}_{k(=4˜n)}, RX₂_{_{—}}_{k(=1˜n)}).

Similarly, when the judgment unit 105 analyzes that the amplitudes A of at least two (for example, but not limited to, IS₂_{_{—}}₁, IS₂_{_{—}}ₙ) of the inductive signals (IS₂_{_{—}}₁ to IS₂_{_{—}}ₙ) are different from the amplitudes A of the remaining inductive signals CS₁_{_{—}}_{k(=1˜n)}, CS₂_{_{—}}_{k(=2˜n-1)}, then the judgment unit 105 judges that there is the occurrence of the multi-touch event (i.e. two-touch event). The reason is that the inductive capacitors CS₂_{_{—}}₁ and CS₂_{_{—}}ₙ varied and the remaining inductive capacitors CS₁_{_{—}}_{k(=1˜n)}, CS₂_{_{—}}_{k(=2˜n-1)} did not vary and, as a result, the amplitudes A of the inductive signal (IS₂_{_{—}}₁, IS₂_{_{—}}ₙ) respectively provided by the receiver patterned electrode (RX₂_{_{—}}₁, RX₂_{_{—}}ₙ) are different from (e.g. greater than or smaller than) the amplitudes A of the inductive signals (IS₁_{_{—}}₁ to IS₁_{_{—}}ₙ, IS₂_{_{—}}₂ to IS₂_{_{—}}ₙ₋₁) respectively provided by the remaining receiver patterned electrodes (RX₁_{_{—}}₁ to RX₁_{_{—}}ₙ, RX₂_{_{—}}₂ to RX₂_{_{—}}ₙ₋₁).

For yet another example, when the judgment unit 105 analyzes that the amplitudes A of five (for example, but not limited to, IS₂_{_{—}}₁ to IS₂_{_{—}}₅) of the inductive signals (IS₂_{_{—}}₁ to IS₂_{_{—}}ₙ) are different from the amplitudes A of the remaining inductive signals CS₁_{_{—}}_{k(=1˜n)}, CS₂_{_{—}}_{k(=6˜n)}, then the judgment unit 105 judges that there is the occurrence of the multi-touch event (i.e. five-touch event). The reason is that the inductive capacitors CS₂_{_{—}}_{k(=1˜5)} varied and the remaining inductive capacitors CS₁_{_{—}}_{k(=1˜n)}, CS₂_{_{—}}_{k(=6˜n)} did not vary and, as a result, the amplitudes A of the inductive signal IS₂_{_{—}}_{k(=1˜5)} respectively provided by the receiver patterned electrode RX₂_{_{—}}_{k(=1˜5)} are different from (e.g. greater than or smaller than) the amplitude A of the inductive signals (IS₁_{_{—}}_{k(=1˜n)}, IS₂_{_{—}}_{k(=6˜n)}) respectively provided by the remaining receiver patterned electrodes (RX₁_{_{—}}_{k(=1˜n)}, RX₂_{_{—}}_{k(=6˜n)}).

Based on the above teachings of exemplary single-touch, two-touch, three-touch, four-touch and five-touch detection schemes, people skilled in the art would be able to deduce the more-than-five-touch detection scheme by analogy and, therefore, the more-than-five-touch detection scheme is not discussed herein.

It is noted that, in order for the above exemplary touch detection schemes to successfully achieve their intended purposes, in this exemplary embodiment illustrated in FIG. 2A, a scanning frequency Fss (i.e. the reciprocal of scanning period Tss of the scan signals (SS1, SS2), FSS=(1/TSS)) corresponding to the scan signals (SS1, SS2) must be higher than a frame rate of the LCD module 101. For example, assuming the frame rate of the LCD module 101 is 60 Hz, the scanning frequency Fss corresponding to the scanning signals (SS1, SS2) must be higher than 60 Hz, for example, but not limited to, 100 Hz. In other words, the scanning frequency corresponding to the scanning signals (SS1, SS2) may be determined according to actual requirements. In addition, because the common electrode layer 101g of the LCD module 101 can provide shielding function, the touch detection schemes of the above various exemplary embodiments can avoid misdetection/misjudgment due to affection of noises from the LCD module 101 and can thus achieve accurate single-touch and/or multi-touch detection/judgment with high signal-to-noise ratio (SNR).

In summary, various embodiments of the present invention provide a capacitive touch display apparatus having an on-cell-like touch panel, the touch detection schemes of which can be carried out using simplified hardware structures and can achieve accurate single-touch and/or multi-touch detection/judgment with high SNR.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A capacitive touch display apparatus, comprising:
a liquid crystal display module comprising:
an active device array substrate;
a color filter substrate; and
a liquid crystal layer disposed between an inner side of the active device array substrate and an inner side of the color filter substrate;
a touch panel comprising:
a single touch sensing layer fabricated on an outer side of the color filter substrate, the single touch sensing layer comprising a first transmitter patterned electrode and a plurality of first receiver patterned electrodes corresponding to the first transmitter patterned electrode, wherein there is a first inductive capacitor between each of the first receiver patterned electrodes and the first transmitter patterned electrode, and the first inductive capacitors are equal to each other; and
a cover lens disposed on the single touch sensing layer; and
a judgment unit electrically connected with the first transmitter patterned electrode and the first receiver patterned electrodes, and configured to transmit a first scan signal to the first transmitter patterned electrode and determine whether there is an occurrence of a single-touch event or a multi-touch event by analyzing a plurality of first inductive signals from the respective first receiver patterned electrodes.

2. The capacitive touch display apparatus according to claim 1, wherein the single touch sensing layer further comprises a second transmitter patterned electrode and a plurality of second receiver patterned electrodes corresponding to the second transmitter patterned electrode, and there is a second inductive capacitor between each of the second receiver patterned electrodes and the second transmitter patterned electrode, and the second inductive capacitors are equal to the first inductive capacitors.

3. The capacitive touch display apparatus according to claim 2, wherein:
the judgment unit is further electrically connected with the second transmitter patterned electrode and the second receiver patterned electrodes, and
the judgment unit is further configured to transmit a second scan signal following the first scan signal to the second transmitter patterned electrode, and determine whether there is the single-touch event or the multi-touch event by simultaneously analyzing the first inductive signals and a plurality of second inductive signals from the respective receiver patterned electrodes.

4. The capacitive touch display apparatus according to claim 3, wherein at least one of the first inductive capacitors and the second inductive capacitors varies with the occurrence of the single-touch event or the multi-touch event.

5. The capacitive touch display apparatus according to claim 4, wherein:
when the judgment unit analyzes that amplitudes of the first inductive signals and amplitudes of the second inductive signals are the same, the judgment unit determines that there is no the occurrence of the single-touch event or the multi-touch event,
when the judgment unit analyzes that the amplitude of only one of the first inductive signals is different from the amplitudes of the remaining first inductive signals and the second inductive signals, the judgment unit determines that there is the occurrence of the single-touch event,
when the judgment unit analyzes that the amplitude of only one of the second inductive signals is different from the amplitudes of the remaining second inductive signals and the first inductive signals, the judgment unit determines that there is the occurrence of the single-touch event,
when the judgment unit analyzes that the amplitudes of at least one of the first inductive signals and at least one of the second inductive signals are different from the amplitudes of the remaining first inductive signals and the remaining second inductive signals, the judgment unit determines that there is the occurrence of the multi-touch event,
when the judgment unit analyzes that the amplitudes of at least two of the first inductive signals are different from the amplitudes of the remaining first inductive signals and the second inductive signals, the judgment unit determines that there is the occurrence of the multi-touch event, and
when the judgment unit analyzes that the amplitudes of at least two of the second inductive signals are different from the amplitudes of the remaining second inductive signals and the first inductive signals, the judgment unit determines that there is the occurrence of the multi-touch event.

6. The capacitive touch display apparatus according to claim 4, wherein a scanning frequency corresponding to the first and second scan signals is higher than a frame rate of the liquid crystal display module.

7. The capacitive touch display apparatus according to claim 1, wherein the liquid crystal display module further comprises:
an active array device layer disposed on the inner side of the active device array substrate;
a first alignment layer disposed between the active device array layer and the liquid crystal layer;
a second alignment layer disposed between the color filter substrate and the liquid crystal layer;
a common electrode layer disposed between the color filter substrate and the second alignment layer; and
a color filter layer disposed between the color filter substrate and the common electrode layer.

8. The capacitive touch display apparatus according to claim 7, wherein the liquid crystal display module further comprises:
a lower polarizer disposed on an outer side of the active device array substrate; and
a backlight module disposed below the lower polarizer.

9. The capacitive touch display apparatus according to claim 8, wherein the touch panel further comprises:
an upper polarizer disposed on the single touch sensing layer; and
a transparent adhesive layer disposed between the cover lens and the upper polarizer.

10. The capacitive touch display apparatus according to claim 9, wherein the transparent adhesive layer is an optically-clear adhesive layer or a liquid optically-clear adhesive layer.
